(19) United States
(12) Patent Application Publication
(10) Pub. No.: US 2008/0159223 A1
(43) Pub. Date: Jul. 3, 2008

(54) METHOD AND APPARATUS FOR MAINTAINING CALL CONTINUITY BETWEEN PACKET AND CIRCUIT DOMAINS IN A WIRELESS COMMUNICATION SYSTEM

(76) Inventors: Sudeep K. Palat, Swindon (GB); Said Tatesh, Swindon (GB); Alessio Casati, Swindon (GB); Christophe Demarez, Swindon (GB)

Correspondence Address: TERRY D. MORGAN;Williams, Morgan & Amerson, P.C., Suite 1100, 10333 Richmond, Houston, TX, 77042, US

(21) Appl. No.: 11/618,234

(22) Filed: Dec. 29, 2006

(51) Int. Cl. H04Q 7/00

(52) U.S. Cl. 370/331

(57) ABSTRACT

The present invention provides a method applicable to a mobile unit operating using Long Term Evolution (LTE) technology and having a single radio interface. The method controls a handover from a Voice over Internet Protocol (VoIP) call to a Circuit Switched (CS) call. The method comprises providing a CS call control message in a packet switched message, and routing the CS call control messages to a Mobile Switching Centre (MSC). Thereafter, a handover of the VoIP call to the CS call is initiated in response to receiving the call control message.

### BACKGROUND OF THE INVENTION

1. Field of the Invention

This invention relates generally to communication systems, and, more particularly, to wireless communication systems.

2. Description of the Related Art

In conventional wireless communications, one or more mobile units (or access terminals) may establish a wireless link with a base station so that the mobile unit may communicate data and/or voice signals wirelessly therebetween. The base station ultimately communicates with a data network, such as the Internet, and/or a Public Switched Telephone Network (PSTN) so that the mobile unit may access data and/or make telephone calls.

There are many different types of wireless communications system, each having different attributes. For example, the Global System for Mobile communication (GSM) and early versions of the Universal Mobile Telecommunication System (UMTS) can only support voice over circuit switched (CS) networks. Long Term Evolution (LTE), as defined by 3GPP, on the other hand, supports packet switched (PS) Internet Protocol (IP) based services. Thus, voice calls over LTE are supported by Voice over IP (VoIP).

To keep costs reasonable, some mobile units may not support access to multiple radio interfaces simultaneously. Thus, ordinarily, the mobile units are capable of accessing only one technology, either GSM, UMTS or LTE at any given time. Thus, it may occur that a mobile unit operating using the LTE technology is located in a weak LTE signal area, and, thus, cannot initiate a circuit switched voice call if it encounters a system that supports GSM or UMTS supporting only circuit switched voice, as is often the case in developing countries.

Generally, 3GPP has specified a mechanism for handling this situation. In particular, 3GPP provides for HandOver (HO) of a call from VoIP to CS, which is commonly referred to as Voice Call Continuity (VCC). However, the mechanism in 3GPP will not operate properly for a mobile unit configured to access LTE technology. For a HO from VoIP to CS, VCC requires the mobile unit to set up a CS call with a GSM/UMTS Mobile Switching Centre (MSC). The MSC then contacts a VoIP call control residing in the IP Multi-media Subsystem (IMS) domain. The call is then handed over to the CS domain. Thus, VCC requires simultaneous access to the CS and PS networks during execution of the HO procedure. A mobile device configured to access LTE technology, however, is not capable of accessing the CS network simultaneously. Accordingly, VCC cannot be used directly for HO from LTE to GSM/UMTS.

### SUMMARY OF THE INVENTION

The present invention is directed to addressing the effects of one or more of the problems set forth above. The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

In one embodiment of the present invention, a method is provided for controlling a handover from a Voice over Internet Protocol (VoIP) call to a Circuit Switched (CS) call. The method comprises providing a CS call control message in a packet switched message, and routing the CS call control messages to a Mobile Switching Centre (MSC). Thereafter, a handover of the VoIP call to the CS call is initiated in response to receiving the call control message.

### BRIEF DESCRIPTION OF THE DRAWINGS

The invention may be understood by reference to the following description taken in conjunction with the accompanying drawings, in which like reference numerals identify like elements, and in which:

FIG. 1 conceptually illustrates a first exemplary embodiment of a distributed wireless communication system, in accordance with the present invention;

FIG. 2 conceptually illustrates a functional block diagram one exemplary embodiment of a base station and associated circuitry useful for handling a handover of a VoIP call to a CS call; and

FIG. 3 conceptually illustrates the handover procedure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It may of course be appreciated that in the development of any such actual embodiment, numerous implementation-specific decisions should be made to achieve the developers' specific goals, such as compliance with system-related and business-related constraints, which may vary from one implementation to another. Moreover, it will be appreciated that such a development effort might be complex and time-consuming, but may nevertheless be a routine undertaking for those of ordinary skill in the art having the benefit of this disclosure.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

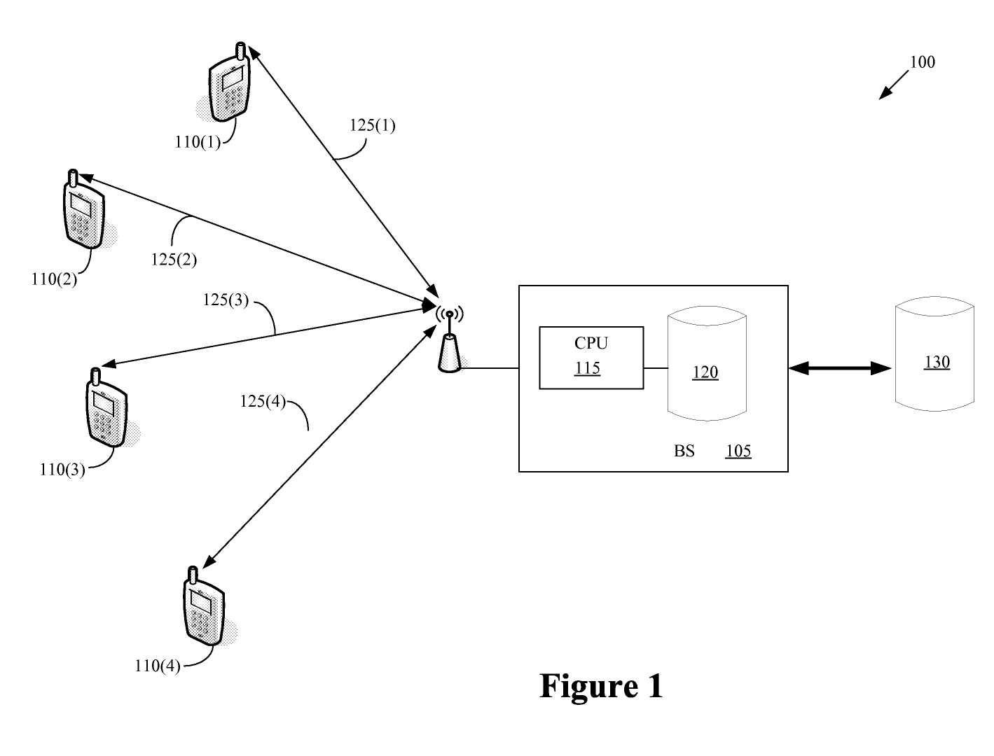

FIG. 1 conceptually illustrates a first exemplary embodiment of a distributed wireless communication system 100. In the first exemplary embodiment, access points for the distributed wireless communication system 100 include a distributed network of base stations 105 (only one shown in FIG. 1). Although the present invention will be described in the context of the distributed wireless communication system 100 comprising one or more base stations 105, persons of ordinary skill in the art should appreciate that the present invention is not limited to distributed wireless communication systems 100 in which the access points are base stations 105. In alternative embodiments, the distributed wireless communication system 100 may include any desirable number and/or type of access point.

The wireless communication system 100 provides wireless connectivity to one or more mobile units 110(1-4). Hereinafter, in the interest of clarity, the mobile units 110(1-4) will be referred to collectively by the index 110 unless the description is referring to a specific mobile unit, such as the mobile unit 110(1), or a subset of the mobile units 110, such as the mobile units 110(1-2). This invention may also be applied to other elements that are indicated by a common numeral and one or more distinguishing indices. In the illustrated embodiment, the wireless communication system 100 provides wireless connectivity to the mobile units 110 according to the GSM or UMTS protocol. However, persons of ordinary skill in the art having benefit of the present disclosure should appreciate that the present invention is not limited to this protocol. In alternative embodiments, other protocols may be used in place of or in combination with the GSM or UMTS protocol.

The base station 105 is capable of initiating, establishing, maintaining, transmitting, receiving, terminating, ending, or performing other actions related to a session with one or more of the mobile units 110. The base stations 105 may also be configured to communicate with other base stations 105, other devices, other networks, and the like. In the illustrated embodiment, processing tasks performed by the base station 105 are carried out by a central processing unit (CPU) 115 implemented in the base station 105. The base station 105 also includes resident memory 120 that may be used to store software used to implement various tasks carried out by the base station 105, as well as information associated with operation of the base station 105. The resident memory 120 is configured to permit relatively fast access to information stored thereon, at least in part to reduce delays associated with initiating, establishing, maintaining, transmitting, receiving, terminating, or performing other actions related to a session with one or more of the mobile units 110.

The base station 105 is also configured to create, assign, transmit, receive, and/or store information related to the sessions established between the base stations 105 and the one or more mobile units 110. This information will be collectively referred to hereinafter as session state information, in accordance with common usage in the art. For example, the session state information may include information related to an air interface protocol, one or more sequence numbers, a re-sequencing buffer, and the like. The session state information may also include information related to a Point-to-Point Protocol (PPP), such as header compression information, payload compression information, and related parameters. Session state information related to other protocol layers may also be created, transmitted, received, and/or stored by the base stations 105.

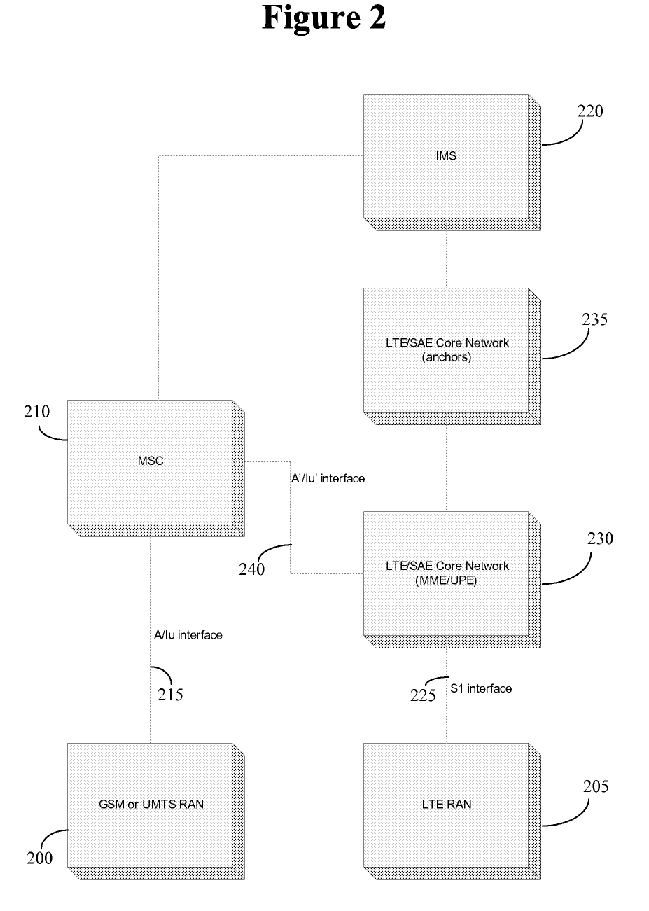

FIG. 2 illustrates a more detailed description of functional blocks associated with the base stations 105 and/or other network circuitry operating in concert with the base stations 105, such as a radio network controller (RNC)(not shown). In particular, a pair of radio access Networks (RANs) 200, 205 are shown. The RAN 200 is based on the GSM or UMTS standard and operates to communicate with mobile units 110 that are similarly equipped. The RAN 205 is based on the LTE standard and it also operates to communicate with mobile units 110 that are likewise equipped. While the mobile units 110 can support both the GSM/UMTS and LTE standards, it cannot operate more than one at any given time.

The GSM/UMTS RAN 200 communicates with a Mobile Switching Center (MSC) 210 over an interface 215 commonly referred to as the A/Iu interface. The MSC 210 is also coupled to a conventional IP Multi-media Subsystem (IMS) 220, which, as described in greater detail below is generally responsible for establishing a CS voice call, as required by VCC.

The LTE RAN 205 is coupled over an S1 interface 225 to a Mobility Management Entity/User Plane Entity (MME/UPE) 230, and through anchors 235 to the IMS 220 in a conventional manner. This path is used to transmit packets of data in a VoIP application, as is conventional in an LTE based system. In the embodiment illustrated in FIG. 2, an additional interface 240 is coupled between the MME/UPE 230 and the MSC 210, and is referred to herein as an A′/Iu′ interface because of its substantial similarity to the A/Iu interface 215.

In the case where the mobile unit 110 is an LTE type device that is currently engaged in a VoIP call, but is moving outside of LTE coverage, the call needs to be handed over to the underlying GSM or UMTS networks. In the illustrated embodiment of the instant invention, this handover can be accomplished using VCC. But to use VCC, the mobile unit 110 first attempts to establish a CS voice call with the GSM/UMTS network. To establish the CS voice call, the LTE mobile unit 110 “transports” (or tunnels) CS call control messages within its PS messages.

The MME/UPE 230 may be configured in a variety of ways to recognize the CS call control messages within the PS message. In one embodiment of the instant invention, a specific information element is included in the PS message that is recognizable by the MME/UPE 230. All subsequent information contained in the PS message, up to a specified length, is forwarded to the MSC 210 by the MME/UPE 230. The CS call control messages themselves are not changed by the MME/UPE 230, but rather, are recognized by the MME/UPE 230 and routed to the MSC 210 over the A′/Iu′ interface 240. The A′/Iu′ interface 205 is not present in a conventional GSM/UMTS network, but rather, has been added to accommodate this special routing by the MME/UPE 230.

Thus, the CS call control messages contained in the PS messages from the mobile unit 110 are sent to the MSC 210 in the GSM/UMTS network from a mobile unit 110 that uses only the LTE protocol during the HO initialization. This routing advantageously allows the MSC 210 to then contact the IMS 225 to initiate a HO using VCC. After successfully establishing the call control, the mobile unit 110 is handed over the GSM/UMTS RAN and the voice bearers over the radio is established on the GSM/UMTS RAN.

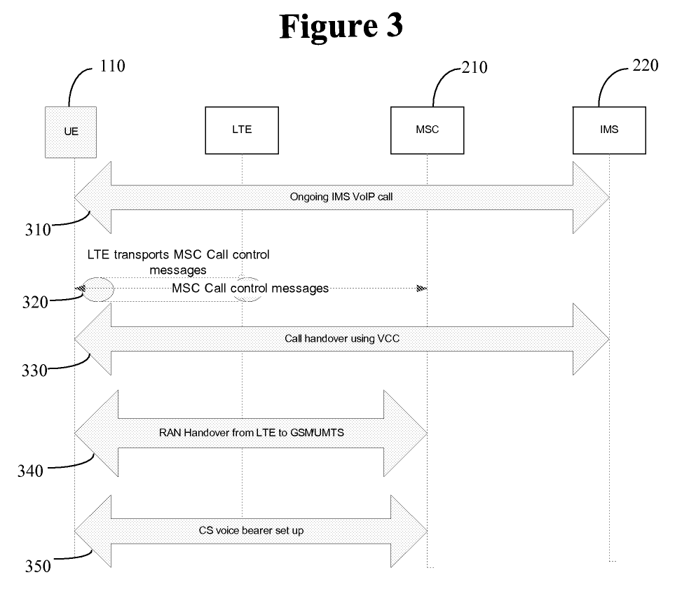

The handover procedure is stylistically represented in FIG. 3. The process begins with the mobile unit 110 engaged in an IMS VoIP call, as represented by the double ended arrow 300 extending between the mobile unit 110 and the IMS 220. At 310, the need to switch from a VoIP call to a CS call is identified, and the mobile unit 110 begins to transmit call control messages within its packet switched messages. These call control messages are recognized by the MME/UPE 230 and routed to the MSC 210 over the A′/Iu′ interface 240, instead of processing the message or passing it to the IMS 220. At 320, the MSC 210 communicates with the IMS 220 and initiates a call handover using VCC without the need for simultaneous access to the CS and PS networks. Thereafter, at 330 RAN handover occurs from the LTE RAN 205 to the GSM/UMTS RAN 200. Finally, at 340 the CS voice bearer is set up and handover is complete.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the invention. Accordingly, the protection sought herein is as set forth in the claims below.

What is claimed is:

1. A method for controlling a handover from a Voice over Internet Protocol (VoIP) call to a Circuit Switched (CS) call, comprising:
providing a CS call control message in a packet switched message;
routing the CS call control message to a Mobile Switching Centre (MSC); and
initiating a handover of the VoIP call to the CS call in response to receiving the call control message.

2. A method, as set forth in claim 1, wherein providing the CS call control message in the packet switched message further comprises including a specific information element in the PS message.

3. A method, as set forth in claim 2, wherein routing the CS call control message to the MSC further comprises routing the CS call control message to the MSC in response to receiving the specific information element.

4. A method, as set forth in claim 1, wherein routing the CS call control message to the MSC further comprises receiving the CS call control message at the MME and delivering the CS call control message to the MSC.

5. A method, as set forth in claim 4, wherein delivering the CS call control message to the MSC further comprises delivering the CS call control message directly to the MSC over a bus.

6. A method, as set forth in claim 1, wherein initiating the handover of the VoIP call to the CS call in response to receiving the call control message further comprises contacting an Internet Protocol Multi-media Subsystem (IMS) to initiate the handover.

7. A method, as set forth in claim 6, wherein contacting the IMS to initiate the handover further comprises contacting the IMS to initiate the handover using Voice Call Continuity (VCC).

8. A method for controlling a handover from a Voice over Internet Protocol (VoIP) call to a Circuit Switched (CS) call, comprising:
receiving a CS call control message in a packet switched message;
routing the CS call control message to a Mobile Switching Centre (MSC); and
initiating a handover of the VoIP call to the CS call in response to receiving the call control message.

9. A method, as set forth in claim 8, wherein receiving the CS call control message in the packet switched message further comprises receiving a specific information element in the PS message;

10. A method, as set forth in claim 9, wherein routing the CS call control message to the MSC further comprises routing the CS call control message to the MSC in response to receiving the specific information element.

11. A method, as set forth in claim 8, wherein routing the CS call control message to the MSC further comprises receiving the CS call control message at the MME and delivering the CS call control message to the MSC.

12. A method, as set forth in claim 11, wherein delivering the CS call control message to the MSC further comprises delivering the CS call control message directly to the MSC over a bus.

13. A method, as set forth in claim 8, wherein initiating the handover of the VoIP call to the CS call in response to receiving the call control message further comprises contacting an Internet Protocol Multi-media Subsystem (IMS) to initiate the handover.

14. A method, as set forth in claim 13, wherein contacting the IMS to initiate the handover further comprises contacting the IMS to initiate the handover using Voice Call Continuity (VCC).

15. A method for initiating a handover from a Voice over Internet Protocol (VoIP) call to a Circuit Switched (CS) call, comprising:
providing a CS call control message in a packet switched message to a first Radio Access Network (RAN); and
receiving an indication that the call has been handed over to a second RAN.

16. A method, as set forth in claim 15, wherein providing the CS call control message in the packet switched message further comprises including a specific information element in the PS message indicating that the packet switched message contains A CS call control message.
